(19) United States
(12) Patent Application Publication
(10) Pub. No.: US 2026/0018647 A1
(43) Pub. Date: Jan. 15, 2026

(54) SEPARATOR SUPPLY APPARATUS

(71) Applicant: SK ON CO., LTD., Seoul (KR)

(72) Inventor: Hyung Min GO, Daejeon (KR)

(21) Appl. No.: 19/266,177

(22) Filed: Jul. 11, 2025

(30) Foreign Application Priority Data
Jul. 12, 2024 (KR) 10-2024-0092341
Oct. 31, 2024 (KR) 10-2024-0152530

(51) Int. Cl. H01M 10/04; B65H 54/54; H01M 50/403

(52) U.S. Cl. CPC H01M 10/0404; B65H 54/54; H01M 50/403

(57) ABSTRACT

A separator supply apparatus for supplying a separator includes a bobbin support member including a first surface facing a supply position, a position in which a supplied separator is disposed, and a second surface opposite to the first surface, a plurality of bobbin holders disposed on the first surface and the second surface respectively and supporting the separators, at least one of which is disposed in the supply position, a first shaft disposed on the bobbin support member in a direction penetrating the first and second surfaces, and a second shaft providing a rotational axis to the bobbin support member. The plurality of bobbin holders revolve around at least one of the first or second shaft and are provided such that a bobbin holder disposed in the supply position is changed.

### CROSS-REFERENCE TO RELATED APPLICATION(S)

This patent document claims the priority and benefits of Korean Patent Application No. 10-2024-0092341 filed on Jul. 12, 2024 and No. 10-2024-0152530 filed on Oct. 31, 2024, the disclosure of which is incorporated herein by reference in its entirety.

### TECHNICAL FIELD

The disclosure and implementations disclosed in this patent document generally relate to a separator supply apparatus.

### BACKGROUND

Secondary batteries, unlike primary batteries, are convenient in that they may be charged and discharged, and are thus receiving a large amount of attention as power sources for various mobile devices and electric vehicles.

Secondary batteries, unlike primary batteries, may be charged and discharged, and may thus be applied to devices within various fields such as digital cameras, mobile phones, laptops, hybrid cars, electric vehicles, and energy storage systems (ESS).

These secondary batteries may include a battery cell in which an electrode assembly formed by stacking a cathode plate, an anode plate, and a separator or by being wound in a roll shape is accommodated inside a case.

Meanwhile, in the process of manufacturing a battery cell, the separator may be wound in a roll shape and then unwound and provided. At this time, when the separator is completely used up, a separate time is required to replenish the separator, which increases the manufacturing time of the secondary battery.

Therefore, research on a supply device that may quickly replace the separator is being conducted importantly.

### SUMMARY

The present disclosure may be implemented in some embodiments to provide a separator supply apparatus in which a separator may be quickly replaced or supplemented.

Meanwhile, the separator supply apparatus of the present disclosure may be widely applied to devices within green technology fields such as electric vehicles, battery charging stations, and solar power generation and wind power generation using batteries. In addition, the separator supply apparatus of the present disclosure may be used in eco-friendly electric vehicles, hybrid vehicles, and the like to ameliorate the effects of climate change by suppressing air pollution and greenhouse gas emissions.

In some embodiments of the present disclosure, a separator supply apparatus for supplying a separator includes a bobbin support member including a first surface facing a supply position, a position in which a supplied separator is disposed, and a second surface opposite to the first surface; and a plurality of bobbin holders disposed on at least one of the first surface or the second surface and supporting the separator, at least one of the plurality of bobbin holders being disposed in the supply position. The bobbin support member further includes a first shaft and a second shaft intersecting the first shaft, and the plurality of bobbin holders revolve around at least one of the first shaft or the second shaft and are provided such that a bobbin holder disposed in the supply position is changed.

In an embodiment, the plurality of bobbin holders may be disposed adjacent to each other centered on the first shaft on at least one of the first surface or the second surface.

In an embodiment, the plurality of bobbin holders may revolve around the first shaft and may be provided so that a bobbin holder located in the supply position is changed to another bobbin holder disposed adjacent thereto.

In an embodiment, the plurality of bobbin holders may be protruded parallel to the first shaft on at least one of the first surface or the second surface.

In an embodiment, the bobbin support member may rotate around the second shaft so that the second surface faces the supply position, to rotate the plurality of bobbin holders relative to the second shaft.

In an embodiment, the first shaft and the second shaft may be orthogonal to each other.

In an embodiment, the plurality of bobbin holders may be disposed adjacent to each other in a circumferential direction centered on the first shaft.

In an embodiment, the first shaft may protrude from at least one of the first surface or the second surface of the bobbin support member, and the second shaft may protrude from the bobbin support member in a direction perpendicular to the first shaft.

In an embodiment, the first shaft may be a virtual axis defined as a center axis of revolving of the plurality of bobbin holders, and the second shaft may be a virtual axis defined as a rotational center axis of the bobbin support member.

In some embodiments of the present disclosure, a separator supply apparatus for supplying a separator includes a bobbin support member including a supply position in which a supplied separator is disposed; and a plurality of bobbin holders supporting the separator, at least one of the plurality of bobbin holders being disposed in the supply position. The plurality of bobbin holders are provided by revolving around a first shaft such that a bobbin holder disposed in the supply position is changed.

In an embodiment, the plurality of bobbin holders may be disposed adjacent to each other centered on the first shaft on at least one surface of the bobbin support member.

In an embodiment, the first shaft may be a virtual axis defined as a center axis of revolving of the plurality of bobbin holders.

In some embodiments of the present disclosure, a separator supply apparatus for supplying a separator includes a bobbin support member including a first surface facing a supply position, a position at which a supplied separator is disposed, and a second surface opposite to the first surface; and a plurality of bobbin holders supporting the separator, and disposed on at least one of the first surface or the second surface, at least one of the plurality of bobbin holders being disposed in the supply position. The bobbin support member includes a second shaft disposed in a direction perpendicular to a direction toward the first and second surfaces. The bobbin support member is provided by rotating around the second shaft so that the second surface faces the supply position and positions of the first surface and the second surface are mutually changed.

In an embodiment, the bobbin support member may be provided by rotating such that at least one of the plurality of bobbin holders disposed on the second surface is disposed in the supply position.

In an embodiment, the second shaft may be a virtual axis defined as a rotational center axis of the bobbin support member.

### BRIEF DESCRIPTION OF DRAWINGS

Certain aspects, features, and advantages of the present disclosure are illustrated by the following detailed description with reference to the accompanying drawings.

FIG. 1 is a schematic diagram of a secondary battery manufacturing apparatus according to an embodiment.

FIG. 2 is a diagram illustrating an electrode gripper advancing toward a separator according to an embodiment.

FIG. 3 is a diagram illustrating electrode grippers being alternately disposed and received into an alignment box according to an embodiment.

FIG. 4 is a diagram illustrating a separator being finished according to an embodiment.

FIG. 5 is a diagram illustrating pressing by a separator pressing member according to an embodiment.

FIG. 6 is a diagram illustrating an electrode gripper being detached according to an embodiment.

FIG. 7 is a diagram illustrating an electrode assembly being formed in an alignment box according to an embodiment.

FIG. 8A is a plan view illustrating an electrode being supported by an electrode gripper according to an embodiment, and FIG. 8B is a plan view illustrating an electrode being supported by an electrode gripper according to another embodiment.

FIG. 9 is a perspective view of an alignment box according to an embodiment.

FIG. 10 is a plan view illustrating a state in which an electrode gripper is inserted into an alignment box according to an embodiment.

FIG. 11 is a flow chart of a secondary battery manufacturing method according to an embodiment.

FIG. 12 is a flow chart illustrating in detail the manufacturing method of FIG. 11.

FIG. 13 is a perspective view of a separator supply apparatus according to an embodiment.

FIG. 14 is a drawing illustrating replenishing a separator by revolving around a first shaft according to an embodiment.

FIG. 15 is a drawing illustrating replenishing a separator by rotating based on a second shaft according to an embodiment.

FIG. 16 is a perspective view of a separator supply apparatus according to another embodiment.

### DETAILED DESCRIPTION

Features of the present disclosure disclosed in this patent document are described by example embodiments with reference to the accompanying drawings.

Before going into the detailed description of the embodiments, the terms or words used in the following description and claims should not be interpreted as limited to their usual or dictionary meanings, but should be interpreted as meanings and concepts that conform to the technical idea of the present disclosure based on the principle that the inventor may appropriately define the concept of the term to explain his or her own invention in the best way.

The same reference numbers or symbols described in respective drawings represent parts or components that perform substantially the same function. For the convenience of explanation and understanding, the same reference numbers or symbols may be used in different embodiments to describe parts or components.

In the following description, the singular expression includes the plural expression unless the context clearly indicates otherwise. It should be understood that the terms “comprise,” “include,” “configure,” and the like are intended to specify the presence of a feature, number, step, operation, component, part, or combination thereof described in the specification, but do not preclude the possibility of the presence or addition of one or more other features, numbers, steps, operations, components, parts, or combinations thereof.

In addition, in the following description, the expressions such as upper side, upper, lower side, lower, side, front, rear, back, and the like are expressed based on the direction illustrated in the drawing, and it is noted in advance that they may be expressed differently if the direction of the corresponding object changes.

In addition, in the following description and claims, terms including ordinal numbers such as “first”, “second”, and the like may be used to distinguish between components. These ordinals are used to distinguish between identical or similar components, and the meaning of the terms should not be limited due to the use of these ordinals. For example, components combined with these ordinals should not be limited in their use order or arrangement order, and the like by their numbers. If necessary, respective ordinal numbers may be used interchangeably.

Hereinafter, the present disclosure will be described in detail with reference to the drawings.

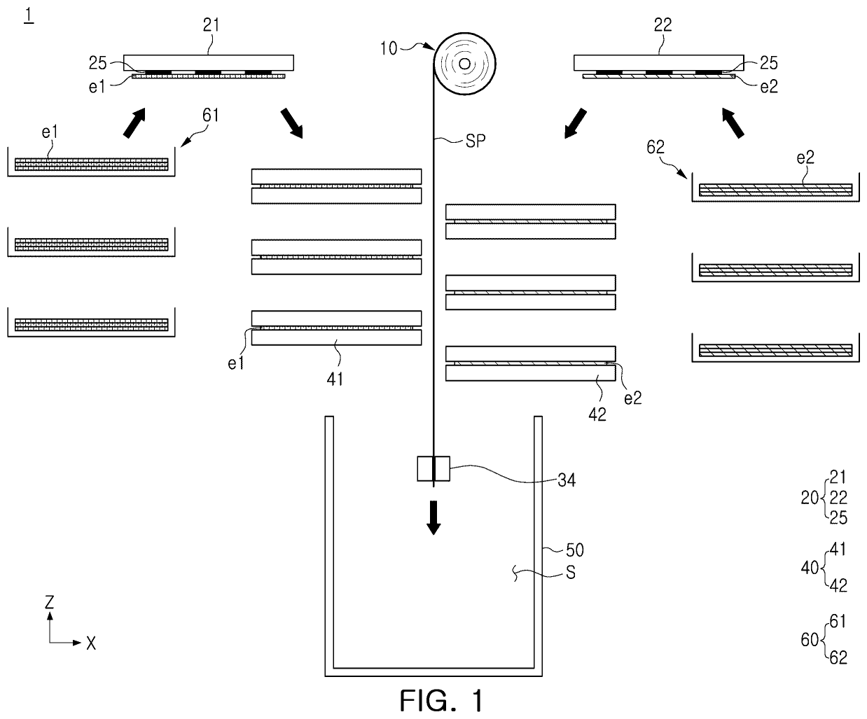

FIG. 1 is a schematic diagram of a secondary battery manufacturing apparatus according to an embodiment.

A secondary battery manufacturing apparatus 1 according to an embodiment may include a separator supply apparatus 10 that supplies a separator SP, an electrode gripper 40 including a first electrode gripper 41 and a second electrode gripper 42 facing each other with the separator SP interposed therebetween, an electrode magazine 60 that loads electrodes, an electrode supply unit 20 that supplies electrodes from the electrode magazine 60 to the electrode gripper 40, and an alignment box 50 in which an electrode assembly EA is formed.

In detail, a secondary battery manufacturing apparatus according to an embodiment may include an alignment box 50 including an alignment space S, a plurality of first electrode grippers 41 disposed to be spaced apart from each other in an extension direction (Z-axis) of the separator SP on one side of the separator SP extending toward the alignment box 50, and supporting a first electrode e1, and a plurality of second electrode grippers 42 disposed to face the gap between the plurality of first electrode grippers 41 on the other side of the separator SP, and supporting a second electrode e2. In this case, the plurality of first electrode grippers 41 and the plurality of second electrode grippers 42 may move to be aligned in the alignment space S while intersecting each other with the separator SP therebetween, so that the first electrode e1 and the second electrode e2 are alternately stacked in the alignment space S with the separator SP therebetween.

Hereinafter, the detailed configuration of the present disclosure will be described in detail.

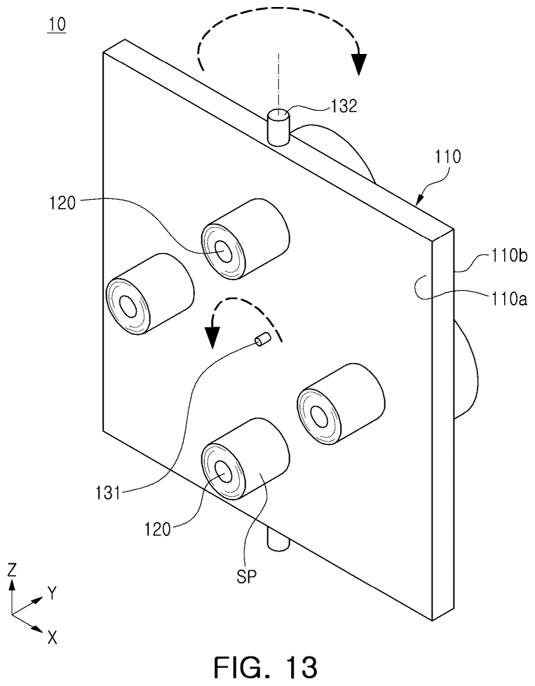

The separator supply apparatus 10 may supply the separator SP toward the alignment box 50. For example, the separator SP may be wound in a roll shape, loaded into the separator supply apparatus 10, and then supplied while unwinding. The separator SP may be supplied in a direction (−Z axis) toward the alignment box 50 by the separator supply apparatus 10. The detailed structure of the separator supply apparatus 10 according to an embodiment will be described later, after FIG. 13.

The electrode magazine 60 may accommodate a plurality of electrodes. The electrode magazine 60 may include a first electrode magazine 61 that accommodates a first electrode e1 and a second electrode magazine 62 that accommodates a second electrode e2. According to an embodiment, the electrode magazine 60 and the electrode supply unit 20 may be provided in a number corresponding to that of the electrode grippers 40. However, the present disclosure is not limited thereto, and it may be possible to provide only one first electrode magazine 61 and one second electrode magazine 62. In addition, according to an embodiment, the electrode magazine 60 may be adjusted to correspond to the size of the electrodes e1 and e2. For example, if the size of the electrode is larger or smaller than that of the electrodes e1 and e2 in the illustrated drawing, the electrode magazine 60 may be changed to a corresponding size.

Meanwhile, in the present disclosure, the first electrode e1 and the second electrode e2 may be electrode plates having opposite polarities. According to an embodiment, the first electrode e1 may have one polarity of a cathode or an anode, and the second electrode e2 may have one polarity of the other. For example, the first electrode e1 may be a cathode plate and the second electrode e2 may be an anode plate. However, the present disclosure is not limited thereto.

The electrode supply unit 20 may extract the electrodes e1 and e2 from the electrode magazine 60 and supply the electrodes to the electrode gripper 40. The electrode supply unit 20 may include a first electrode supply unit 21 extracting the first electrode e1 from the first electrode magazine 61 and a second electrode supply unit 22 extracting the second electrode e2 from the second electrode magazine 62. The first electrode supply unit 21 may supply the first electrode e1 to the first electrode gripper 41 described below, and the second electrode supply unit 22 may supply the second electrode e2 to the second electrode gripper 42 described below.

In addition, the electrode supply unit 20 according to an embodiment may further include a suction portion 25 that forms a vacuum pressure and is sucked by the electrodes e1 and e2. The suction portion 25 may be provided to each of the first electrode supply unit 21 and the second electrode supply unit 22. The suction portion 25 may suck the suction areas Sa of the electrodes e1 and e2. As the suction portion 25, at least one suction portion may be disposed in the electrode supply unit 20, to face the electrode magazine 60. The suction portion 25 may suck at least one surface of each of the electrodes e1 and e2 like a suction cup so that the electrodes e1 and e2 may be temporarily attached to the electrode supply unit 20. According to an embodiment, the electrode supply unit 20 may suction the electrodes e1 and e2 by the suction portion 25 while being disposed close to the electrodes e1 and e2 loaded in the electrode magazine 60, so that the electrodes e1 and e2 are attached thereto. The electrode supply unit 20 may extract the electrodes e1 and e2 from the electrode magazine 60 in this state and supply the electrodes e1 and e2 to the electrode gripper 40.

However, the means for picking up the electrodes e1 and e2 in the present disclosure is not limited to the suction portion 25. A separate jig member may be provided to pick up the electrodes e1 and e2.

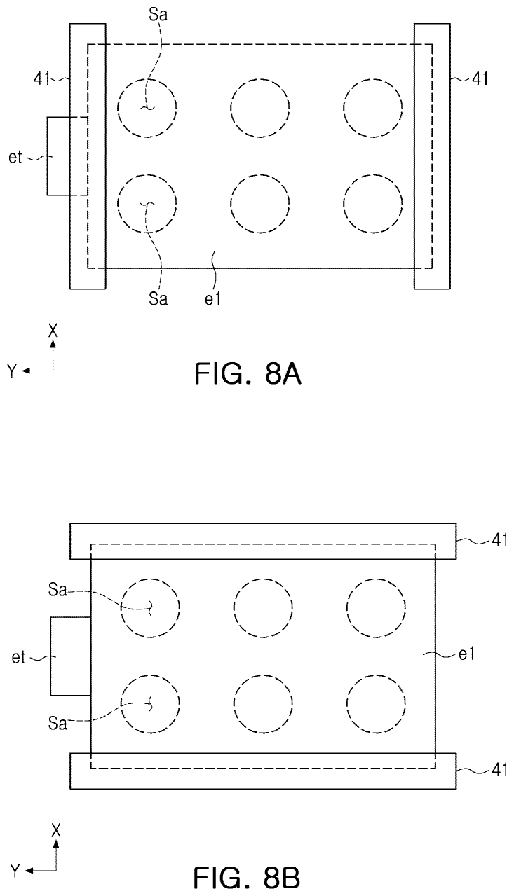

The electrode gripper 40 may alternately stack the electrodes e1 and e2 while being received in the alignment box 50 in a state in which the electrodes e1 and e2 are gripped thereby. The electrode gripper 40 may include a first electrode gripper 41 that grips the first electrode e1 and a second electrode gripper 42 that grips the second electrode e2. The first electrode gripper 41 and the second electrode gripper 42 may each be provided in multiples. The electrode gripper 40 according to an embodiment may be provided to support at least one side edge of the electrodes e1 and e2 (see FIGS. 8A and 8B). Therefore, the electrodes e1 and e2 may be pressed by a separator pressing portion 35 described later.

As described later, the first electrode gripper 41 and the second electrode gripper 42 may be stacked in the height direction (Z-axis) while approaching each other while facing each other with the separator SP interposed therebetween. The structure for manufacturing a secondary battery through the electrode gripper 40 will be described later.

The alignment box 50 may include an alignment space S in which a plurality of first electrodes e1 and a plurality of second electrodes e2 are stacked with a separator SP therebetween to form an electrode assembly EA. As described below, when the electrode gripper 40 is inserted into the interior of the alignment box 50, the first electrodes e1 and the second electrodes e2 may be stacked with the separator SP therebetween. In addition, the secondary battery manufacturing apparatus 1 according to an embodiment may further include a separator gripper 34 that grips the separator SP and guides the separator to the alignment box 50. The separator gripper 34 may grip one end of the initially supplied separator SP and guide the separator SP while moving to the alignment space S of the alignment box 50. In detail, the separator gripper 34 may grip one end of the separator SP and extend the separator SP toward the alignment box 50 while moving toward the alignment box 50. In this case, the end of the separator SP refers to an initial end of the separator SP provided from the separator supply apparatus 10, and may refer to an end of the provided separator SP that is disposed close to the alignment box 50.

As described below, the separator gripper 34 may move in a direction approaching (−Z axis) or away (+Z axis) from the alignment box 50 to adjust the tension generated when the electrode gripper 40 is inserted to the separator SP. According to an embodiment, as described below, when a plurality of first electrode grippers 41 and a plurality of second electrode grippers 42 intersect with each other with the separator SP interposed therebetween, the separator gripper 34 may be provided to move in a direction away from the alignment box (+Z axis) to adjust tension. In addition, as described below, the electrode assembly EA formed through stacking in the alignment box 50 may be transported to a device in which a subsequent secondary battery manufacturing process is performed.

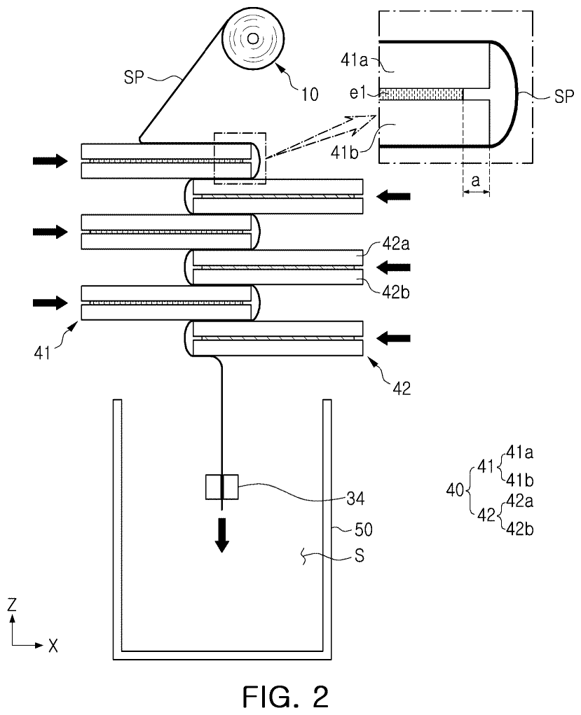

Hereinafter, a process of manufacturing an electrode assembly EA by stacking a first electrode e1 and a second electrode e2 will be described with reference to FIGS. 2 to 7.

FIG. 2 is a drawing illustrating an electrode gripper moving forward toward a separator according to an embodiment.

Referring to FIG. 2, a plurality of first electrode grippers 41 and a plurality of second electrode grippers 42 may move closer to each other while being disposed to face each other with the separator SP interposed therebetween. In detail, a plurality of first electrode grippers 41 may be spaced apart from each other by a predetermined distance in the height direction (Z-axis), and a plurality of second electrode grippers 42 may be disposed to face the space spaced between the plurality of first electrode grippers 41. In detail, the plurality of second electrode grippers 42 may be disposed between the plurality of first electrode grippers 41 along the extension direction or height direction (Z-axis) of the separator SP.

In this state, a plurality of first electrode grippers 41 and a plurality of second electrode grippers 42 may move toward the separator SP and bend the separator SP. At this time, the plurality of first electrode grippers 41 and the plurality of second electrode grippers 42 may bend the separator SP while intersecting each other with the separator SP therebetween.

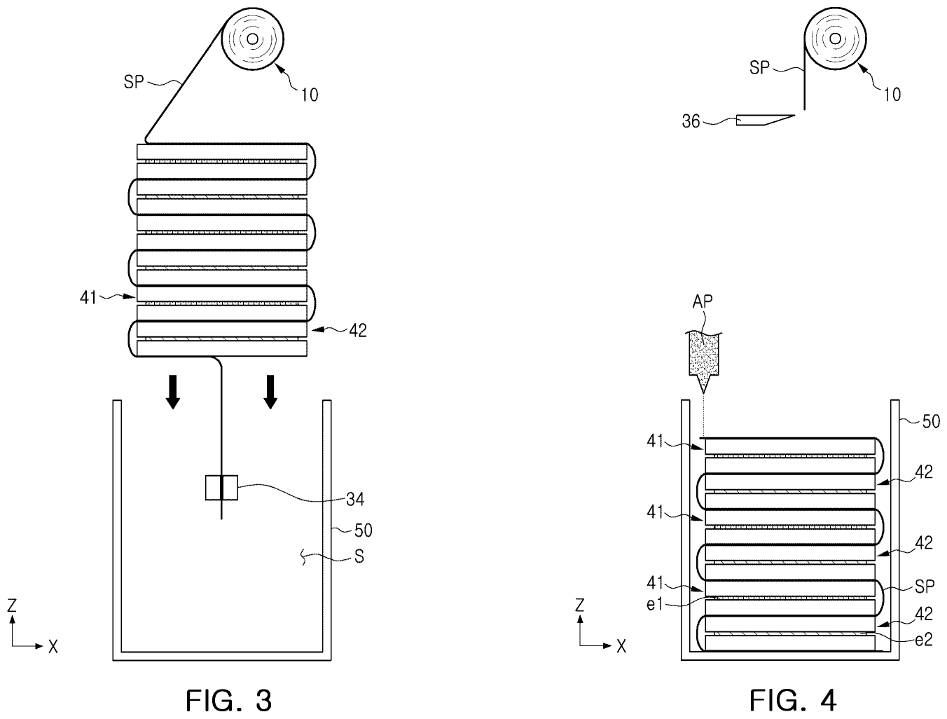

In this case, the meaning of ‘intersecting’ may include a state in which the plurality of first electrode grippers 41 and the plurality of second electrode grippers 42 are alternately disposed in the extension direction (Z-axis) of the separator with the separator SP therebetween, and are disposed so that at least portions thereof overlap each other along that direction (Z-axis) (see FIG. 2 and FIG. 3). Therefore, the electrode grippers 40 may bend the separator SP in a zigzag shape while pushing the separator SP on both sides of the separator SP. ‘Aligning in the alignment space in a intersecting state’ may mean that a plurality of first electrode grippers 41 and a plurality of second electrode grippers 42 intersect each other as illustrated in FIG. 3, and then are alternately aligned or disposed in the alignment space S. Therefore, in the present disclosure, stacking of the first electrode e1 and the second electrode e2 may be performed in the alignment space S.

In addition, the meaning of ‘bending the separator SP’ may mean including the electrode gripper 40 moving toward the separator SP and pushing the separator SP.

According to an embodiment, the electrode gripper 40 may be disposed to protrude a predetermined distance (a) further toward the separator SP than the electrodes e1 and e2. Therefore, when the electrode gripper 40 comes into contact with the separator SP and bends the separator SP, the electrodes e1 and e2 are prevented from being damaged by preventing the electrodes e1 and e2 from directly coming into contact with the separator SP. For example, by causing the electrode gripper 40 to protrude further than the electrodes e1 and e2 in the direction toward the separator SP, the end of the electrode gripper 40, not the electrodes e1 and e2, may enable the separator SP to be bent. In detail, at least one of the plurality of first electrode grippers 41 or the plurality of second electrode grippers 42 may protrude further than the electrodes e1 and e2 by a predetermined distance (a) toward the separator SP. In detail, according to an embodiment, at least one of the plurality of first electrode grippers 41 or the plurality of second electrode grippers 42 may have an end facing the separator SP, which protrudes a predetermined distance further in the direction toward the separator than the first electrode e1 or the second electrode e2, respectively.

In this case, the meaning of the ‘predetermined distance’ may include a distance that prevents the electrodes e1 and e2 from directly contacting the separator SP when the electrode grippers 41 and 42 intersect. Therefore, the ends of the electrode grippers 41 and 42, not the electrodes e1 and e2, may contact the separator SP to push and bend the separator SP. In detail, the ‘predetermined distance’ may mean a distance that is not particularly limited as long as it prevents the electrodes e1 and e2 from directly contacting the separator SP.

According to an embodiment, the first electrode gripper 41 may include an upper first electrode gripper 41a and a lower first electrode gripper 41b disposed with the first electrode e1 therebetween. For example, the upper/lower first electrode grippers 41a and 41b may stably grip the first electrode e1 like a pair of forceps. Similarly, the second electrode gripper 42 may include an upper second electrode gripper 42a and a lower second electrode gripper 42b disposed with the second electrode e2 therebetween. For example, the upper/lower second electrode grippers 42a and 42b may stably grip the second electrode e2 like a pair of forceps.

Meanwhile, tension may be applied to the separator SP as the plurality of first electrode grippers 41 and the plurality of second electrode grippers 42 are disposed to be intersected with each other. According to an embodiment, the tension applied to the separator SP may be offset by adjusting the separator (SP) supply speed of the separator supply apparatus 10 according to the tension applied to the separator SP. Alternatively, according to an embodiment, the separator gripper 34 may move upward (+Z axis) toward the electrode gripper 40 to offset the tension applied to the separator SP.

FIG. 3 is a drawing illustrating that the electrode grippers are disposed alternately and received into the alignment box according to an embodiment.

Referring to FIG. 3, the plurality of first electrode grippers 41 and the plurality of second electrode grippers 42 may be further advanced in the direction toward the separator SP and may be disposed alternately along the supply direction or the separator SP or the height direction (Z-axis). Therefore, the plurality of first electrodes e1 and the plurality of second electrodes e2 may be disposed sequentially with the separator SP interposed therebetween. In this way, the plurality of first electrode grippers 41 and the plurality of second electrode grippers 42 may be inserted into the alignment space S of the alignment box 50 in a state where they are arranged sequentially in the height direction (Z-axis).

FIG. 4 is a drawing illustrating that the separator is finished according to an embodiment.

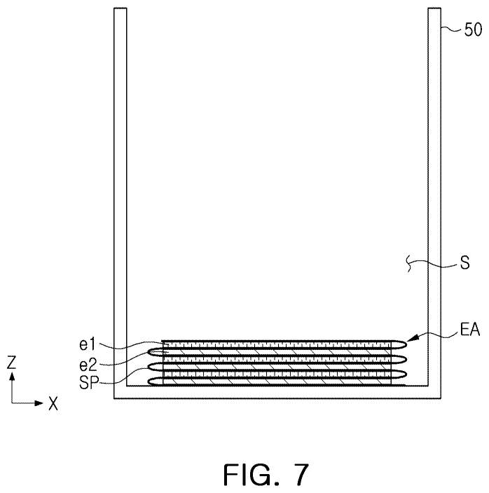

Referring to FIG. 4, the present disclosure may further include a separator cutter 36 and an adhesive portion AP. According to an embodiment, the separator cutter 36 may cut the end of the separator SP accommodated in the alignment space S. The cut end of the separator SP may be provided as one end initially provided in the subsequent process of manufacturing the secondary battery. The adhesive portion AP may be finished by applying an adhesive to the cut separator SP. For example, the adhesive portion AP may be applied to the separator SP in which the electrodes e1 and e2 are inserted by the electrode gripper 40. The adhesive portion AP may be finished by applying an adhesive to a portion of the separator SP adjacent to the top of the stacked separator SP. In the drawing, the adhesive portion AP is illustrated as applying the adhesive in a state where the electrode gripper 40 is disposed, but this is for helping understanding, and the adhesive may also be applied to the separator SP in a state where the electrode gripper 40 is detached, as illustrated in FIG. 7.

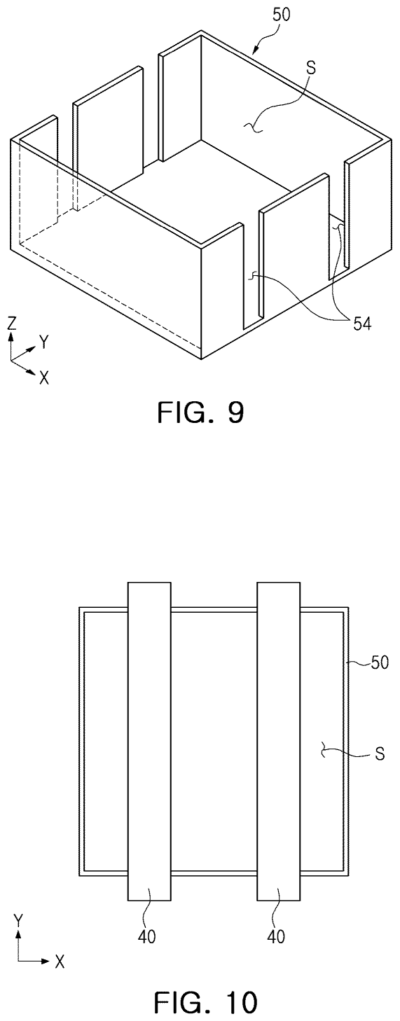

Meanwhile, referring to FIG. 4, a plurality of first electrode grippers 41 and a plurality of second electrode grippers 42 may be accommodated in the alignment space S of the alignment box 50. In this way, the placement error between the first electrode grippers 41 and the second electrode grippers 42 may be adjusted during the process of being accommodated in the alignment box 50. In detail, as described later in FIG. 9, the plurality of first electrode grippers (41) and the plurality of second electrode grippers (42) move in the height direction (Z-axis) along the alignment groove (54) of the alignment box (50), so that the error in the direction (X-axis or Y-axis) perpendicular to the height direction (Z-axis) can be adjusted.

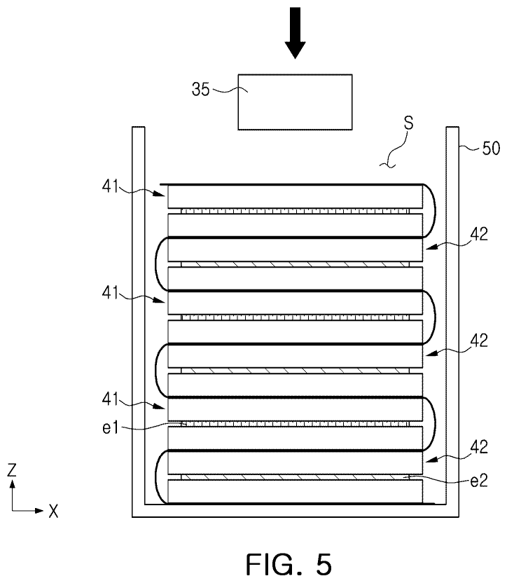

FIG. 5 is a drawing illustrating pressing with a separator pressing member according to an embodiment.

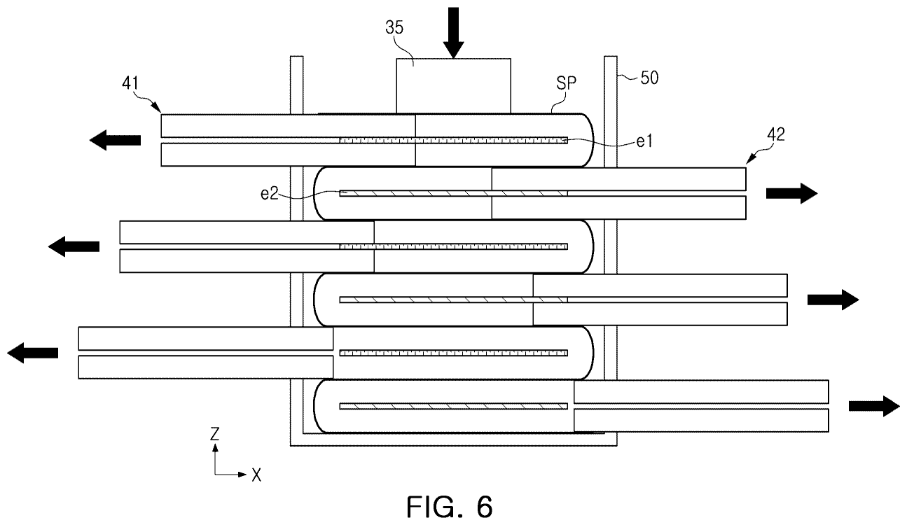

Referring to FIG. 5, embodiments of the present disclosure may further include a separator pressing portion 35 that presses the electrodes e1 and e2 accommodated in the alignment box 50. The separator pressing portion 35 may move toward the alignment box 50 in which a plurality of the first electrode grippers 41 and a plurality of the second electrode grippers 42 are accommodated, and pressurize at least one of the electrodes e1 and e2, the separator SP, or the electrode gripper 40. In detail, the separator pressing portion 35 may press downward the separator SP stacked at the top, and pressurize the electrodes e1 and e2 disposed therebetween. During this time, the electrode gripper 40 may be separated from the alignment space S. Therefore, as described later in FIG. 6, even if the electrode gripper 40 is separated from the electrodes e1 and e2, the electrodes e1 and e2 may be prevented from being separated from the separator SP. In detail, the separator pressing portion 35 may be provided to pressurize the centers of the electrodes e1 and e2 (see FIGS. 8A and 8B) so that the electrode gripper 40 is not pressed. Therefore, the separator pressing portion 35 may directly pressurize the separator SP and the electrodes e1 and e2 excluding the electrode gripper 40. The electrode gripper 40 is not directly pressed by the separator pressing portion 35, and may thus be separated from the electrodes e1 and e2 and fall out of the alignment box 50 as described later. For example, the separator pressing portion 35 may pressurize the upper part in a state where a plurality of first electrode grippers 41 and a plurality of second electrode grippers 42 are sequentially disposed in the height direction (Z-axis) with the separator SP interposed therebetween. In the drawing, the separator pressing portion 35 is depicted as pressurizing the upper separator SP, but this is for convenience of understanding, and the present disclosure is not limited thereto. For example, the separator pressing portion 35 according to an embodiment is not particularly limited as long as it may prevent the electrodes e1 and e2 from being separated from the separator SP when the electrode gripper 40 is separated from the separator SP.

Meanwhile, in an embodiment not illustrated, the separator pressing portion 35 may include an air blower that pressurizes the electrodes e1 and e2 by blowing compressed air, which may significantly reduce damage to components such as the separator SP and prevent the electrodes e1 and e2 from being separated from the separator SP when the electrode gripper 40 is separated.

FIG. 6 is a drawing illustrating the detachment of the electrode gripper according to an embodiment.

Referring to FIG. 6, when the separator pressing portion 35 pressurizes the electrodes e1 and e2, the electrode gripper 40 may be detached from the separator SP.

According to an embodiment, a plurality of electrode grippers 40 may be detached in a direction opposite to the direction in which they entered. At this time, the separator pressing portion 35 may prevent the electrodes e1 and e2 from being separated from the separator SP while pressurizing the electrodes e1 and e2. However, the present disclosure is not limited thereto, and the electrode gripper 40 may be separated laterally perpendicular to the direction in which it entered. In addition, in an embodiment not illustrated, the upper/lower first electrode grippers 41a and 41b and the upper/lower second electrode grippers 42a and 42b may be separated from the separator SP in a state where they are separated from each other in the height direction (Z-axis).

Meanwhile, according to an embodiment, a plurality of first electrode grippers 41 and a plurality of second electrode grippers 42 may be separated sequentially from those disposed downward. However, the present disclosure is not limited thereto.

FIG. 7 is a drawing illustrating an electrode assembly formed in an alignment box according to an embodiment.

Referring to FIG. 7, it can be seen that the electrode gripper 40 is separated from the separator SP and is separated from the alignment space S. At this time, in the alignment space S, the first electrode e1 and the second electrode e2 may be alternately disposed with the separator SP therebetween to form an electrode assembly EA.

In this case, the ‘electrode assembly EA’ in the present disclosure may mean a state in which the first electrode e1 and the second electrode e2 are alternately disposed or stacked with the separator SP therebetween. In detail, as long as the first electrode e1, the separator SP, and the second electrode e2 are alternately disposed, it may be referred to as the electrode assembly in the present disclosure.

In the related art, since the electrode assembly is formed by stacking a separator on a cathode, stacking an anode on the separator, stacking a separator on the anode, and then stacking a cathode on the separator again, there is a problem that the process is complicated and the stacking process takes time. According to the present disclosure, since a plurality of first electrodes e1 and a plurality of second electrodes e2 are simultaneously stacked in an alignment box 50 with a separator SP therebetween, the secondary battery time manufacturing may be further shortened.

Meanwhile, in an embodiment not illustrated, the secondary battery manufacturing apparatus 1 according to an embodiment may further include a driving member (not illustrated) that moves the electrode gripper 40. The driving member may include a guide rail that guides the path along which the electrode gripper 40 moves. In an embodiment, the guide rail of the driving member may be changeably adjusted according to the size of the electrodes e1 and e2. The guide rail is disposed on both sides of the electrodes e1 and e2 in the longitudinal direction (Y-axis) to guide the movement of the electrode gripper 40 and the interval therebetween may be adjusted according to the size of the electrodes e1 and e2. Since one electrode assembly may be manufactured, the cost for designing the manufacturing device may be reduced.

FIG. 8A is a plan view of an electrode gripper supporting an electrode according to an embodiment, and FIG. 8B is a plan view of an electrode gripper supporting an electrode according to another embodiment. FIGS. 8A and 8B are described based on the first electrode e1 and the first electrode gripper 41, but the second electrode e2 and the second electrode gripper 42 may also be applied in the same manner.

Referring to FIG. 8A and FIG. 8B together, the first electrode gripper 41 may support the first electrode e1 by avoiding the suction area Sa where the suction portion (25 of FIG. 1) sucks the electrode e1. For example, the first electrode gripper 41 receives the first electrode e1 through the first electrode supply unit 21 having the suction portion 25, and may thus support the first electrode e1 to avoid interference with the suction portion 25.

Referring to FIG. 8A, the first electrode gripper 41 may support both ends of the first electrode e1 along the longitudinal direction (Y-axis) perpendicular to the direction (X-axis) facing the separator SP. Referring to FIG. 8B, the first electrode gripper 41 may support both ends of the first electrode e1 in the direction (X-axis) facing the separator. In this way, the electrode gripper 40 of the present disclosure is not particularly limited as long as it is provided to support the electrodes e1 and e2 while avoiding the suction area Sa. At this time, the first electrode gripper 41 may protect the first electrode e1 by protruding further than the first electrode e1 in the direction toward the separator SP.

FIG. 9 is a perspective view of an alignment box according to an embodiment, and FIG. 10 is a plan view illustrating a state in which an electrode gripper is inserted into an alignment box according to an embodiment.

Referring to FIG. 9 and FIG. 10, an alignment box 50 according to an embodiment may include an alignment groove 54 into which an electrode gripper 40 is inserted. The alignment groove 54 is extended in the height direction (Z-axis) to guide the electrode gripper 40 to move in the height direction (Z-axis), and may also align a plurality of first electrode grippers 41 and a plurality of second electrode grippers 42 so as not to be misaligned with each other. Therefore, the alignment reliability of the first electrode e1 and the second electrode e2 may be secured.

In addition, according to an embodiment, the shape of

the alignment box 50 is provided in a shape corresponding to that of the electrodes e1 and e2, to prevent the alignment of the electrodes e1 and e2 from being misaligned. In the drawing, the alignment box 50 is depicted as a square shape, but this is an example. The alignment box 50 according to another embodiment may be formed as a rectangular shape that is extended in the longitudinal direction (Y-axis) to correspond to the shape of the electrodes e1 and e2 as in FIGS. 8A and 8B.

According to an embodiment, the electrode gripper 40 is inserted into the alignment space S downward (−Z-axis) along the alignment groove 54, and then the plurality of first electrode grippers 41 move in one direction (−X-axis) away from the separator SP, and the plurality of second electrode grippers 42 move in the other direction (+X-axis) away from the separator SP and are detached.

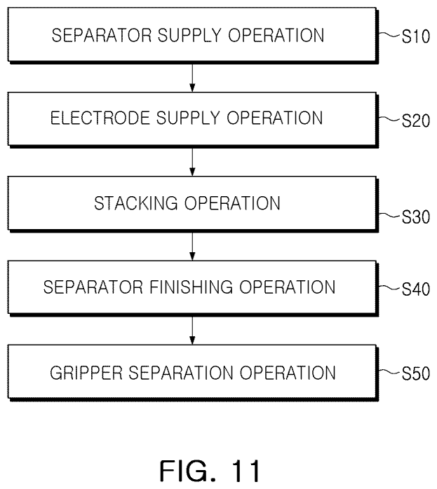

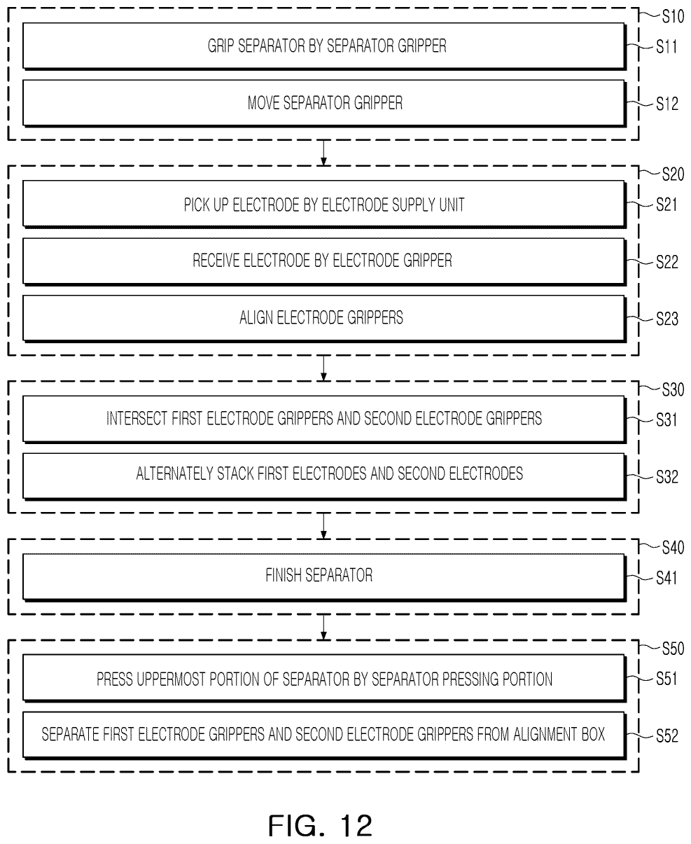

FIG. 11 is a flowchart of a secondary battery manufacturing method according to an embodiment, and FIG. 12 is a flowchart specifically illustrating the manufacturing method of FIG. 11. The description overlapping with the description the secondary battery manufacturing apparatus 1 of FIGS. 1 to 9 will be omitted and provided.

Referring to FIGS. 11 and 12 together, the secondary battery manufacturing method according to an embodiment may include a separator supply operation (S10) of supplying a separator SP, an electrode supply operation (S20) of supplying electrodes e1 and e2 to an electrode gripper 40, and a stacking operation (S30) of disposing a first electrode gripper 41 and a second electrode gripper 42 of the electrode gripper 40 in an alignment box 50.

The separator supply operation (S10) may include an operation of supplying a separator SP from a separator supply apparatus 10 toward an alignment box 50. According to an embodiment, the separator supply operation (S10) may include an operation (S11) in which the separator gripper 34 grips one end (an initial withdrawal portion) of the separator SP and an operation (S12) in which the separator gripper 34 moves toward the alignment box 50 to extend the separator SP. However, this is only an embodiment, and the present disclosure may include any method in which the separator SP may be supplied toward the alignment box 50. According to another embodiment, even without the separator gripper 34, the separator SP may be supplied while the bobbin (120, see FIG. 13) of the separator supply apparatus 10 revolves.

In the electrode supply operation (S20), the electrodes e1 and e2 received in the electrode magazine 60 may be taken out by the electrode supply unit 21, 22, and may be supplied to the electrode gripper 40. The electrode supply operation (S20) according to an embodiment may include an operation (S21) in which the electrode supply unit 20 sucks the electrodes e1 and e2 loaded in the electrode magazine 60 through the suction portion 25 and picks up the electrodes e1 and e2 from the electrode magazine 60, and an operation (S22) in which the electrodes e1 and e2 taken out therefrom are supplied to the electrode gripper 40, and the electrode gripper 40 receives the electrodes e1 and e2 from the electrode supply unit 20 and grips the same.

In addition, the electrode supply operation (S20) according to an embodiment may further include an operation (S23) in which the electrode grippers 40 gripping the electrodes e1 and e2 are alternately aligned on both sides. In detail, the operation (S23) in which the electrode grippers 40 are alternately aligned on both sides may include an operation in which a plurality of first electrode grippers 41 are disposed spaced apart from each other in the extension direction or height direction (Z-axis) on one side of the separator SP, and a plurality of second electrode grippers 42 are disposed between the first electrode grippers 41 on the other side of the separator SP (see FIG. 1).

The stacking operation (S30) may include an operation in which the electrodes e1 and e2 are alternately stacked using the electrode grippers 40.

The stacking operation (S30) according to an embodiment may include an operation (S31) in which the plurality of first electrode grippers 41 and the plurality of second electrode grippers 42 intersect each other with the separator SP interposed therebetween so that the separator SP is bent in a zigzag shape, and an operation (S32) in which the plurality of first electrode grippers 41 and the plurality of second electrode grippers 42 move to an alignment box 50 and are aligned in the alignment box 50, thereby alternately stacking the first electrodes e1 and the second electrodes e2 with the separator SP interposed therebetween. At this time, the plurality of first electrode grippers 41 and the plurality of second electrode grippers 42 may be alternately disposed along the height direction or the stacking direction (Z-axis) inside the alignment box 50.

The operation (S31) of bending the separator in a zigzag shape may bend the separator in a zigzag shape by having a plurality of first electrode grippers 41 and a plurality of second electrode grippers 42 advance toward the separator SP and push the separator from both sides of the separator SP (see FIG. 2). In addition, the operation (S31) of bending the separator in a zigzag shape may further include an operation in which the first electrode gripper 41 and the second electrode gripper 42 are disposed to overlap in the height direction (Z-axis), and in this state, the first electrode gripper 41 and the second electrode gripper 42 are moved to the alignment space S of the alignment box 50 and accommodated. (See FIG. 3)

In addition, the secondary battery manufacturing method according to an embodiment may further include a separator finishing operation (S40) of cutting the separator SP while the electrode gripper 40 is loaded into the alignment space S and finishing the cut end. The separator finishing operation (S40) may include an operation of cutting the separator SP accommodated in the alignment box 50 with a separator cutter 36 and finishing the cut end through an adhesive portion AP. However, the present disclosure is not limited thereto, and the operation of finishing the separator SP with the adhesive portion AP may be performed after a gripper separation operation (S50) described later. In detail, the separator finishing operation (S40) may be included in the present disclosure as long as it includes only the operation of cutting the separator SP.

In addition, the secondary battery manufacturing method according to an embodiment may further include a gripper separation operation (S50) in which the electrode gripper 40 is separated from the separator SP. As described above, the ‘electrode assembly EA’ described in the present disclosure may mean a stack in which the first electrode e1, the separator SP, and the second electrode e2 are alternately stacked.

In the gripper separation operation (S50), the first electrode gripper 41 and the second electrode gripper 42 accommodated in the alignment space S may be separated from the interior of the alignment space S. The gripper separation operation (S50) according to an embodiment may include an operation (S51) in which the separator pressing portion 35 presses downward the top of the separator SP stacked in the alignment box 50, and an operation (S52) in which the plurality of first electrode grippers 41 and the plurality of second electrode grippers 42 are separated from the electrodes e1 and e2 and detached from the alignment box 50, thereby forming an electrode assembly EA.

The operation (S51) of pressing the separator may press the separator SP to prevent the electrodes e1 and e2 from moving together and becoming misaligned when the electrode gripper 40 is detached. Therefore, the electrodes e1 and e2 interposed inside the separator SP may be pressed with a predetermined pressure. In this case, the ‘predetermined pressure’ is sufficient if it is formed to be greater than the frictional force generated between the electrodes e1 and e2 when the electrode gripper 40 is detached, and may prevent the alignment of the electrodes e1 and e2 from being misaligned as the electrode gripper 40 is detached.

At the stage where the electrode gripper 40 is detached, the electrode gripper 40 may be separated from the electrodes e1 and e2 and detached to the outside of the alignment box 50. According to an embodiment, the electrode gripper 40 may be detached through the alignment groove 54 of the alignment box 50. The alignment groove 54 may be formed to extend along the stacking direction (Z-axis) of the electrodes e1 and e2. In detail, in FIGS. 1 to 7, the electrode gripper 40 is illustrated as being smaller than the alignment box 50, but this is an example for the convenience of understanding, and as illustrated in FIG. 10, the electrode gripper 40 may be provided to have a length greater than that of the alignment box 50 in at least one direction. Therefore, the electrode gripper 40 may be guided in the height direction (Z-axis) by the alignment groove 54. In addition, the electrode gripper 40 may be detached from the alignment box 50 through the alignment groove 54.

In addition, according to an embodiment, the detachment direction of the electrode gripper 40 may be the opposite direction to the direction in which the electrode gripper 40 advances toward the separator SP in the stacking operation (S30), for example, may be the direction away from the separator SP. For example, in the case of the plurality of first electrode grippers 41, the first electrode grippers may be separated in the direction (−X-axis) opposite to the forward direction (+X-axis) toward the separator SP. However, the present disclosure is not limited thereto, and it goes without saying that they may be separated in the vertical direction (Y-axis).

When the electrode gripper 40 is detached, a plurality of first electrodes e1 and a plurality of second electrodes e2 may be alternately stacked in the height direction (Z-axis) with the separator SP therebetween in the alignment space S to form an electrode assembly EA. For example, according to the present disclosure, the electrode gripper 40 is received in the alignment space S and then the electrode gripper 40 is detached, thereby forming an electrode assembly EA inside the alignment space S.

In this way, according to the present disclosure, a plurality of first electrodes e1 and a plurality of second electrodes e2 are inserted and stacked at once, thereby shortening the time required for the electrode assembly stacking process.

Meanwhile, according to the separator supply apparatus 10 in an embodiment of the present disclosure, the supply of the exhausted separator SP is smoothly performed without stopping the manufacturing process, thereby further shortening the secondary battery manufacturing time. This will be described below with reference to the drawings.

FIG. 13 is a perspective view of a separator supply apparatus according to an embodiment.

Referring to FIG. 13, the separator supply apparatus 10 according to an embodiment may include a bobbin support member 110, a plurality of bobbin holders 120 that support a separator SP wound by being disposed on the bobbin support member 110, a first shaft 131 (also referred to as a ‘rotation axis’) that is disposed on the bobbin support member 110 and becomes the center of revolving of the plurality of bobbin holders, and a second shaft 132 (also referred to as a ‘replacement axis’) that is disposed to become the rotation center of the bobbin support member 110.

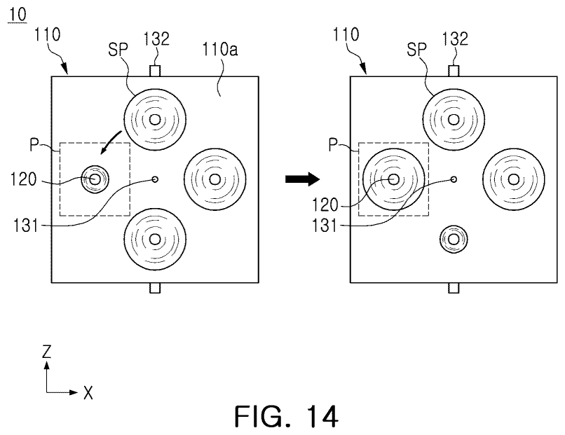

A separator supply apparatus 10 according to an embodiment may supply a separator SP to a secondary battery manufacturing apparatus 1. However, the separator supply apparatus 10 in the present disclosure is not limited to the supply purpose. In detail, a separator supply apparatus 10 according to an embodiment includes a bobbin support member 110 including a first surface 110a facing a supply position P (see FIG. 14) where a supplied separator SP is disposed, and a second surface 110b opposite to the first surface 110a, and a plurality of bobbin holders 120 disposed on the first surface 110a and the second surface 110b respectively to support the separator SP, at least one of which is disposed on the supply position P. The bobbin support member 110 further includes a first shaft 131 and a second shaft 132 intersecting the first shaft 131, and the plurality of bobbin holders 120 may be provided to revolve around at least one of the first shaft 131 or the second shaft 132 so that the bobbin holder 120 disposed in the supply position P is changed.

Meanwhile, “the plurality of bobbin holders 120 revolving around the first shaft 131” may mean that “the plurality of bobbin holders 120 revolve in the circumferential direction of the first shaft 131 with the first shaft 131 as the rotation axis,” and for example, may mean that the bobbin support member 110 is fixed and only the plurality of bobbin holders 120 revolve around the first shaft 131, or the plurality of bobbin holders 120 are fixed to the bobbin support member 110 and the bobbin support member 110 rotates based on the first shaft 131. In addition, “the plurality of bobbin holders 120 revolving around the second shaft 132” may mean that “the plurality of bobbin holders 120 revolve in the circumferential direction of the second shaft 132 with the second shaft 132 as the rotation axis,” and for example, may mean that the bobbin support member 110 is fixed and only the plurality of bobbin holders 120 revolve around the second shaft 132, or that the plurality of bobbin holders 120 are fixed to the bobbin support member 110 and the bobbin support member 110 rotates around the second shaft 132.

The bobbin support member 110 may include a first surface 110a on which a plurality of bobbin holders 120 are disposed, and a second surface 110b which is opposite to the first surface 110a and on which a plurality of bobbin holders 120 are disposed. On the bobbin support member 110, a first shaft 131 that serves as a center of revolving of the plurality of bobbin holders 120 and a second shaft 132 that serves as a rotation center of the bobbin support member 110 may be disposed.

A separator SP may be wound on the bobbin holder 120. The wound separator SP may be provided to the alignment box 50 while the bobbin holder 120 revolves.

According to an embodiment, the bobbin holder 120 is provided in plural and may protrude from at least one of the first surface 110a or the second surface 120b of the bobbin support member 110. According to an embodiment, the bobbin holder 120 may protrude in a direction parallel to the first shaft 130.

The plurality of bobbin holders 120 may be disposed to be adjacent to each other with the first shaft 131 as the center. In this case, “disposing adjacent to each other with the first shaft 131 as the center” may mean at least one of “disposing the plurality of bobbin holders 120 around the first shaft 131” or “disposing the plurality of bobbin holders 120 adjacent to each other along the circumferential direction with the first shaft 131 as the center.” For example, as described later in FIG. 14, if the plurality of bobbin holders 120 are arranged to be disposed so that the bobbin holder 120 in the supply position P may be replaced, while revolving around the first shaft 131 as the center, there is no particular limitation. In this way, according to an embodiment of the present disclosure, the plurality of bobbin holders 120 may quickly replace the used separator SP while revolving around the first shaft 131 as the center. For example, through this structure, the plurality of bobbin holders may revolve around the first shaft 131 so that the bobbin holder 120 located in the supply position P is changed to another bobbin holder 120 disposed adjacent thereto around the first shaft 131. In this case, “the bobbin holder 120 being changed around the first shaft 131” may mean that the plurality of bobbin holders 120 revolve around the first shaft 131, and accordingly, the bobbin holder 120 including a spent separator (SP) disposed in the supply position P is changed to another bobbin holder 120 disposed adjacent thereto in the circumferential direction of the first shaft 131. In the drawing, the supply position P is located in the −X-axis direction of the first surface 110a, but this is only an example, and the position of the supply position P may be changed. In addition, the supply position P may be a relative position defined as a position where the separator SP supplied from the separator supply apparatus 10 is disposed. Accordingly, even if a plurality of bobbin holders 120 or the bobbin support member 110 rotates as illustrated in the drawing, the supply position P may not be changed.

In addition, according to an embodiment of the present disclosure, when the separators SP of the first surface 110a are all exhausted, the bobbin support member 110 may rotate with respect to the second shaft 132 and supply the separator SP through the bobbin holder 120 located on the second surface 110b. For example, the bobbin support member 110 may rotate with respect to the second shaft 132 and thus enable the plurality of bobbin holders 120 to revolve around the second shaft 132. According to an embodiment, the first shaft 131 and the second shaft 132 may be orthogonal to each other. For example, the first shaft 131 and the second shaft 132 may be disposed in directions perpendicular to each other. In detail, the first shaft 131 may be in a direction (Y-axis) that crosses the first surface 110a and the second surface 110b or parallel to the protrusion direction of the bobbin holder 120, and the second shaft 132 may be in a direction (Z-axis) perpendicular to that direction (Y-axis).

Meanwhile, although the first surface 110a and the second surface 110b are indicated in the present disclosure, this does not mean a surface at a specific position, but should be understood as a surface relative to the supply position P. When the bobbin support member 110 rotates based on the second shaft 132 so that the second surface 110b faces the supply position P, the second surface 110b may be referred to as the first surface 110a again.

In addition, in the present disclosure, it is sufficient if a plurality of bobbin holders 120 or the bobbin support member 110 rotates around at least one of the first shaft 131 or the second shaft 132, and it does not necessarily include both the first shaft 131 and the second shaft 132. This will be described in detail below.

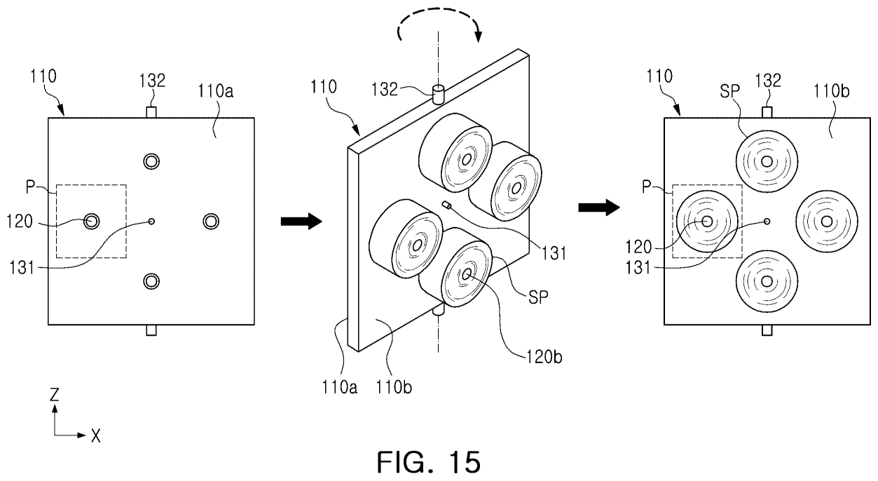

Hereinafter, a separator replenishment structure will be described in detail with reference to FIGS. 14 and 15.

FIG. 14 is a drawing illustrating replenishing a separator by revolving around the first shaft according to an embodiment. Referring to FIG. 14, the separator supply apparatus 10 may be provided to supply a separator SP located in the supply position P. At least one of the plurality of bobbin holders 120 may be located in the supply position P. According to an embodiment, when the separator SP located in the supply position P is exhausted and needs to be replaced, the plurality of bobbin holders 120 may revolve around the first shaft 131 and another bobbin holder 120 adjacent thereto in the circumferential direction may be disposed in the supply position P.

For example, the plurality of bobbin holders 120 may replace a bobbin holder disposed in the supply position P with another bobbin holder 120 adjacent thereto in the circumferential direction, while revolving around the first shaft 131. In this way, when the plurality of bobbin holders 120 on which the separator SP is wound revolve around the first shaft 131, the bobbin holder 120 on which the separator SP is almost exhausted is removed from the supply position P, and another bobbin holder 120 which is adjacent thereto in the circumferential direction and on which the separator SP is wound moves to the supply position P so that the separator SP may be supplied. For example, the bobbin holder on which the separator SP is almost exhausted is replaced with a bobbin holder 120 that is to be disposed in the supply position P while revolving around a first shaft 131. Through this revolving structure, in the present disclosure, immediate replacement may be provided even if the separator SP is exhausted. In this way, the time interrupted to replenish the separator during secondary battery manufacturing is significantly reduced, and thus the secondary battery manufacturing time may be shortened. Meanwhile, in the present disclosure, the ‘supply position P’ may refer to a position where a separator SP supplied to another device, such as a secondary battery manufacturing apparatus 1, is disposed. For example, although the supply position P is depicted as disposed at a 9 o'clock direction clockwise based on the first shaft 131 in the drawing, the present disclosure is not limited thereto, and may be disposed at a 6 o'clock direction or between the 9 o'clock and 6 o'clock directions. In addition, when the separator SP is supplied from multiple locations, a plurality of supply positions P may be formed. In detail, the supply position P in the present disclosure does not mean a specific position, but means a position or area where the separator SP is unwound from the bobbin holder 120. In detail, the supply position P may face the alignment box 50 in a predetermined direction.

Meanwhile, in the drawing, the bobbin support member 110 is depicted as fixed with respect to the first shaft 131, but the present disclosure is not limited thereto, and the bobbin support member 110 itself may rotate with respect to the first shaft 131.

FIG. 15 is a drawing illustrating a method of replenishing a separator by rotating based on a second shaft according to an embodiment. Referring to FIG. 15, the bobbin support member 110 according to an embodiment may replace a plurality of bobbin holders 120 at once while rotating based on a second shaft 132.

According to an embodiment, the bobbin support member 110 may be rotated around the second axis 132 so that the second surface 110b faces the supply position P, thereby allowing the positions of the first surface 110a and the second surface 110b to be interchangeable. Through this structure, at least one of the plurality of bobbin holders 120 disposed on the second surface 110b may be disposed on the supply position P.

In detail, when the separators SP of the plurality of bobbin holders 120 on the first surface 110a are all or nearly exhausted, the bobbin support member 110 may rotate with respect to the second shaft 132. For example, the bobbin support member 110 may be provided to rotate with respect to the second shaft 132 so that the positions of the first surface 110a and the second surface 110b are exchanged with each other. For example, the plurality of bobbin holders 120 may rotate with respect to the second shaft 132 so that the positions are exchanged with each other. Therefore, the plurality of bobbin holders 120 whose separators SP are all or nearly exhausted may be positioned to face the opposite side of the supply position P, and the plurality of bobbin holders 120 on which the separators SP are wound may be disposed to face the supply position P. At this time, the separator SP wound on the bobbin holder 120 of the second surface 110b is supplied to the supply position P, and also, the separator SP may be replenished to the bobbin holder 120 of the first surface 110a disposed to face the opposite side of the supply position P. In this way, in the separator supply apparatus 10 according to an embodiment of the present disclosure, either the first surface 110a or the second surface 110b is positioned to face the supply position P so that the separator SP is supplied, and the other surface is positioned to face the opposite side of the supply position P so that the separator SP is replenished.

In detail, the separator SP is supplied to the first surface 110a facing the supply position P, and the replacement or replenishment of the exhausted separator SP may be performed on the second surface 110b opposite thereto.

In this way, the separator supply apparatus 10 according to an embodiment may rotate through the first shaft 131 to replace the bobbin holder 120 located on one surface 110a or 110b, and rotate through the second shaft 132 to exchange the positions of the first surface 110a and the second surface 110b with each other. Through this dual rotation structure, the separator supply apparatus 10 according to an embodiment may continuously supply the separator SP without a waiting time for replenishment of the separator SP, thereby shortening the manufacturing time of the secondary battery.

In addition, referring again to FIG. 13, the first shaft 131 may protrude from at least one of the first surface 110a or the second surface 110b of the bobbin support member 110. In addition, the second shaft 132 may protrude from the bobbin support member 110 in a direction perpendicular to the first shaft 131. In detail, the second shaft 132 may be protruded in a direction perpendicular to the protrusion direction of the first shaft 131, between the first surface 110a and the second surface 110b.

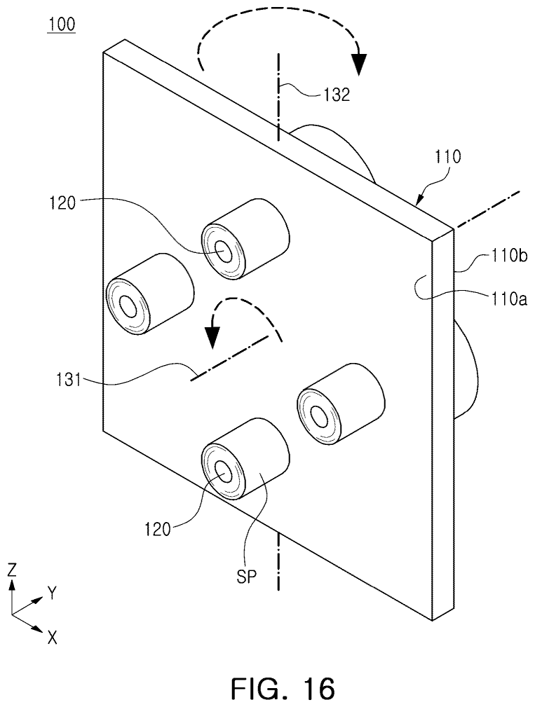

Meanwhile, the first shaft 131 and the second shaft 132 in the present disclosure may be provided as a physical protruding shape as illustrated in FIG. 13, or may be provided as a virtual line as illustrated in FIG. 16, which will be described later. For example, the first shaft 131 and the second shaft 132 may be defined as rotation centers around which a plurality of bobbin holders 120 or the bobbin support member 110 rotates, and do not necessarily have to include a physical shape. For example, in the present disclosure, the first shaft 131 and the second shaft 132 are illustrated as a shape protruding from the bobbin support member 110, but this is only one example, and is not particularly limited as long as it may provide a rotation center of a plurality of bobbin holders 120. For example, the first shaft 131 and the second shaft 132 in the present disclosure may be virtual axes that are disposed in directions intersecting each other. This will be described in detail with reference to the drawings.

FIG. 16 is a perspective view of a separator supply apparatus according to another embodiment. A separator supply apparatus 100 according to another embodiment is intended to explain that the first shaft 131 and the second shaft 132 may be provided as virtual axes, and any content overlapping with that described in FIGS. 13 to 15 is omitted.

The separator supply apparatus 100 according to the embodiment may include a first axis 131 as a virtual line and a second axis 132 as a virtual line. In this case, the first axis 131 may be a virtual axis defined as a center axis of revolving of a plurality of bobbin holders 120, and the second axis 132 may be a virtual axis defined as a rotational center axis of a bobbin support member 110. For example, the first axis 131 may be an axis passing through the center of revolving of a plurality of bobbin holders 120, and the second axis 132 may be an axis passing through the center of rotation of the bobbin support member 110.

As set forth above, in a separator supply apparatus according to an embodiment, the manufacturing time of a secondary battery may be shortened by quickly replacing or replenishing a separator.

Only specific examples of implementations of certain embodiments described. Variations, improvements and enhancements of the disclosed embodiments and other embodiments may be made based on the disclosure of this patent document. Some components of the above-described embodiments may be deleted and implemented, and respective embodiments may be implemented in combination with each other.

The above description is merely an example of applying the principles of the present disclosure, and other configurations may be further included without departing from the scope of the present disclosure.

What is claimed is:

1. A separator supply apparatus for supplying a separator, comprising:
a bobbin support member including a first surface facing a supply position, a position in which a supplied separator is disposed, and a second surface opposite to the first surface; and
a plurality of bobbin holders disposed on at least one of the first surface or the second surface and supporting the separator, at least one of the plurality of bobbin holders being disposed in the supply position,
wherein the bobbin support member further includes a first shaft and a second shaft intersecting the first shaft, and
the plurality of bobbin holders revolve around at least one of the first shaft or the second shaft and are provided such that a bobbin holder disposed in the supply position is changed.

2. The separator supply apparatus of claim 1, wherein the plurality of bobbin holders are disposed adjacent to each other centered on the first shaft on at least one of the first surface or the second surface.

3. The separator supply apparatus of claim 2, wherein the plurality of bobbin holders revolve around the first shaft and are provided so that a bobbin holder located in the supply position is changed to another bobbin holder disposed adjacent thereto.

4. The separator supply apparatus of claim 1, wherein the plurality of bobbin holders are protruded parallel to the first shaft on at least one of the first surface or the second surface.

5. The separator supply apparatus of claim 1, wherein the bobbin support member rotates around the second shaft so that the second surface faces the supply position, to rotate the plurality of bobbin holders relative to the second shaft.

6. The separator supply apparatus of claim 1, wherein the first shaft and the second shaft are orthogonal to each other.

7. The separator supply apparatus of claim 1, wherein the plurality of bobbin holders are disposed adjacent to each other in a circumferential direction centered on the first shaft.

8. The separator supply apparatus of claim 1, wherein the first shaft protrudes from at least one of the first surface or the second surface of the bobbin support member, and
the second shaft protrudes from the bobbin support member in a direction perpendicular to the first shaft.

9. The separator supply apparatus of claim 1, wherein the first shaft is a virtual axis defined as a center axis of revolving of the plurality of bobbin holders, and the second shaft is a virtual axis defined as a rotational center axis of the bobbin support member.

10. A separator supply apparatus for supplying a separator, comprising:
a bobbin support member including a supply position in which a supplied separator is disposed; and
a plurality of bobbin holders supporting the separator, at least one of the plurality of bobbin holders being disposed in the supply position,
wherein the plurality of bobbin holders are provided by revolving around a first shaft such that a bobbin holder disposed in the supply position is changed.

11. The separator supply apparatus of claim 10, wherein the plurality of bobbin holders are disposed adjacent to each other centered on the first shaft on at least one surface of the bobbin support member.

12. The separator supply apparatus of claim 10, wherein the first shaft is a virtual axis defined as a center axis of revolving of the plurality of bobbin holders.

13. A separator supply apparatus for supplying a separator, comprising:
a bobbin support member including a first surface facing a supply position, a position at which a supplied separator is disposed, and a second surface opposite to the first surface; and
a plurality of bobbin holders supporting the separator, and disposed on at least one of the first surface or the second surface, at least one of the plurality of bobbin holders being disposed in the supply position,
wherein the bobbin support member includes a second shaft disposed in a direction perpendicular to a direction toward the first and second surfaces, and
the bobbin support member is provided by rotating around the second shaft so that the second surface faces the supply position and positions of the first surface and the second surface are mutually changed.

14. The separator supply apparatus of claim 13, wherein the bobbin support member is provided by rotating such that at least one of the plurality of bobbin holders disposed on the second surface is disposed in the supply position.

15. The separator supply apparatus of claim 13, wherein the second shaft is a virtual axis defined as a rotational center axis of the bobbin support member.
